(19) United States
(12) Patent Application Publication
(10) Pub. No.: US 2001/0020890 A1
(43) Pub. Date: Sep. 13, 2001

(54) High voltage resistance, particularly for current limitation in a microwave progressive wave tube emitter

(75) Inventors: Guy Colinart, St. Lambert Des Bois (FR); Francois Pacreau, Paris (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THOMSON-CSF, PARIS (FR)

(21) Appl. No.: 09/776,688

(22) Filed: Feb. 6, 2001

(30) Foreign Application Priority Data
Feb. 8, 2000 (FR) 00 01541

(51) Int. Cl. H01C 3/06

(52) U.S. Cl. 338/214

(57) ABSTRACT

This invention relates to a high voltage resistance. The resistance comprises at least one organic substrate (21) and a flat conductor (22) with length L, width l fixed to the organic substrate and with a given resistivity ρ and a thickness ε, the value R of the resistance being equal to ρL/le, the values of the length L, width l being defined such that the mass of the flat conductor (22) is sufficient to resist electrical arcing without exceeding a given temperature. This invention is particularly applicable for current limitation resistances in microwave progressive wave tube emitters, used for example in airborne radar systems.

This invention relates to a high voltage resistance. It is particularly applicable for current limitation resistances in microwave progressive wave tube emitters, for example used in airborne radar systems.

A microwave emission system for radar usually comprises a low power microwave source and means of amplifying the wave produced by this source. These amplification means may be composed of a microwave progressive wave tube. The signal is amplified in a known manner by applying a high voltage between tube electrodes, for example at a voltage of the order of a few tens of kilovolts. At this order of magnitude of voltage, it is impossible to prevent the occurrence of electric arcs. Therefore, current limitation resistances have to be provided, particularly to protect the microwave tube. In particular, the value of these resistances depends on the value of the high voltage applied to the tube and the maximum current that the tube can resist. This maximum current is usually given by the tube manufacturer and for example may reach values of the order of 300 to 1200 amperes.

This type of limitation resistance must be capable of resisting a non-negligible DC power, for example of the order of a hundred watts, in addition to a high voltage. It must be non-inductive, particularly to avoid parasite overvoltages. Preferably, it must also be relatively precise, for example within 5% to 10%, and there must be no drift as a function of ambient conditions or time, in order to control the maximum value of the current that passes through it and on which the tube protection depends.

Limitation resistances, particularly for tube emitters, are known. For example, they may be made of internally conducting ceramic with a cylindrical geometry. However, these resistances have some disadvantages. The first disadvantage is due to the fact that their nominal values vary at random. They also drift in time and as a function of weather conditions. Another important disadvantage is that there is no reliable procurement sources for these resistances. A corollary to this procurement problem is that the cost of these resistances is high. However, quality and reliability of these resistances are essential conditions for smooth operation and industrialization of airborne radar emitters, that are also controlled by severe dimensional constraints and cost constraints. An additional disadvantage is due to the fact that their connections do not satisfactorily resist high voltages.

One particular purpose of the invention is to overcome the disadvantages mentioned above. Consequently, the purpose of the invention is a high voltage resistance comprising at least one support and a flat conductor with length L, width l and thickness e fixed to the support and with a given resistivity ρ, the value R of the resistance being equal to ρL/le, the values of the length L, width l and the thickness e being defined such that the mass of the flat conductor is sufficient to resist electrical arcing without exceeding a given temperature.

For size reasons, the flat conductor is preferably in the shape of a coil comprising parallel conductor segments.

Advantageously, since the support is a flexible organic substrate, the resistance may be folded on itself to reduce its size.

For example, the organic substrate may be fixed onto a ceramic support in particular to enable good heat dissipation.

For example, the resistance may be fixed onto the bottom of a casing and coated with a protective resin to protect the resistance and to fix it to a mechanical support, that may also act as a heat sink.

Another purpose of the invention is an emitter equipped with a limitation resistance as described above.

The main advantages of the invention are that it can be used to make a very compact high voltage resistance, it is very reproducible and economic.

Other characteristics and advantages of the invention will become clear on reading the following description with reference to the attached drawings that show:

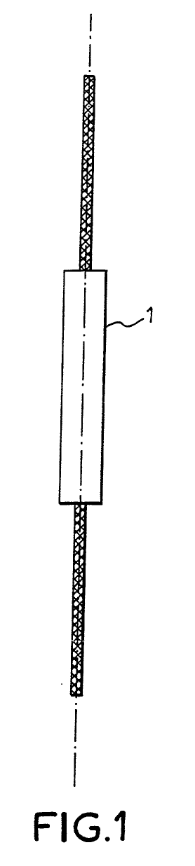

FIG. 1: an embodiment of a high voltage resistance according to prior art;

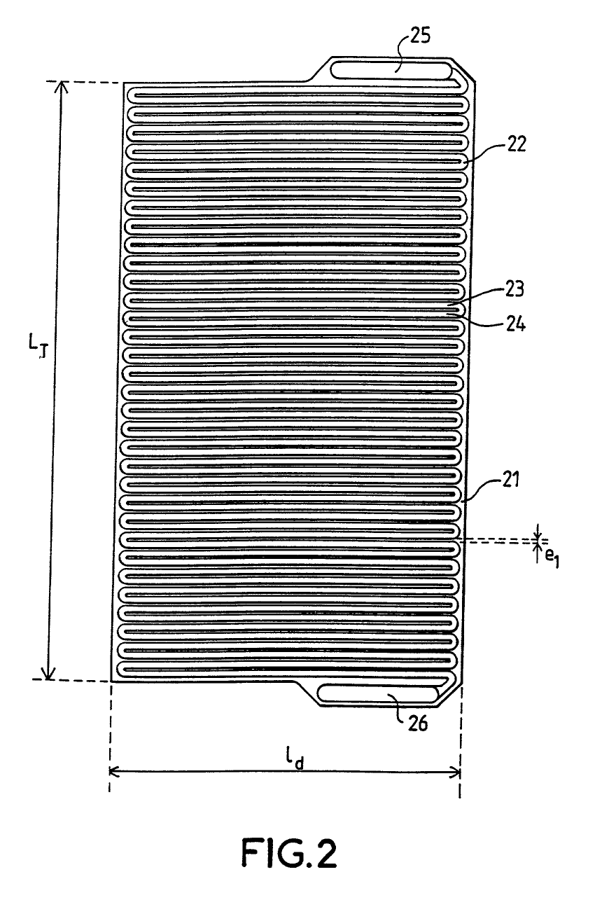

FIG. 2: an embodiment of a high voltage resistance according to the invention;

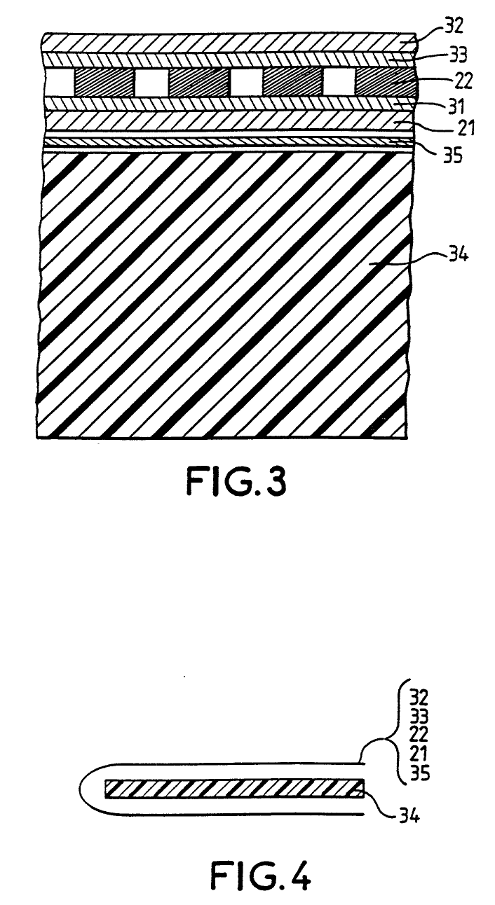

FIG. 3: a sectional view through component layers of an example of a resistance according to the invention;

FIG. 4: an embodiment of a resistance according to the invention in which part of these elements is folded on itself;

FIG. 5: a sectional view through the previous embodiment;

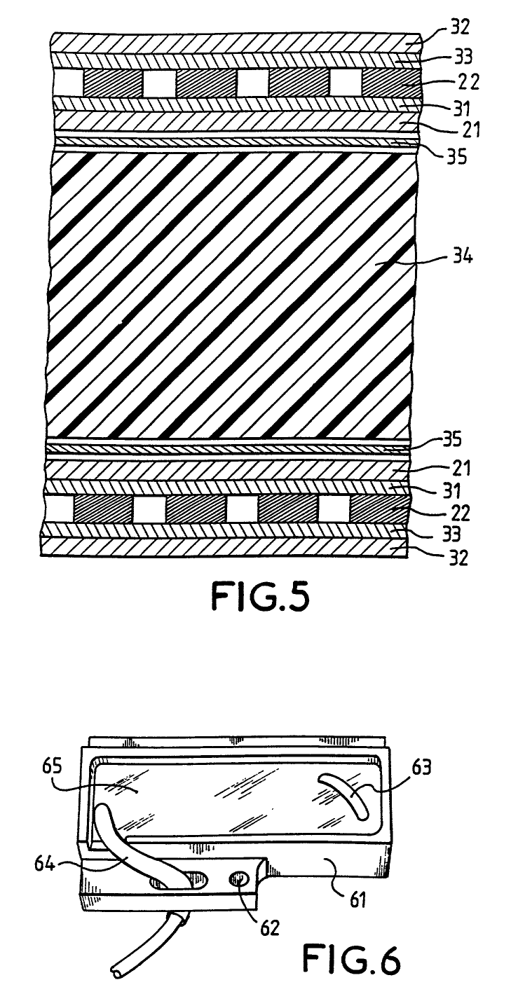

FIG. 6: an embodiment of a resistance according to the invention with a casing.

FIG. 1 is a simplified top view showing an example of high voltage resistances used as limitation resistances in a progressive wave tube emitter made according to prior art. This resistance 1 may be cabled onto the cathode of the emitter tube grid. One way of obtaining the total limitation resistance would be to use two resistances 1 in series or in parallel, particularly due to power constraints. One resistance 1 is made of conducting ceramic and is in the shape of a cylindrical tube. In particular, this resistance 1 has the disadvantage that it has a random nominal value and that it can drift. For example, the drift may be of the order of 20%. Another disadvantage inherent to this resistance is its lack of industrial reliability, which as a corollary induces a high cost. There are very few procurement sources for this type of component and they are not very reliable, particularly due to their very specific nature. However, limitation resistances are of crucial importance for correct operation of the tube emitter.

FIG. 2 illustrates one possible embodiment of a resistance according to the invention that could be used to replace the previous resistance in a tube emitter. This resistance is plane metallic, and is of the printed circuit type. Therefore it comprises at least one dielectric support 21, possibly made of organic material, and a flat conductor 22, the two terminals of the resistance being electrically connected to the ends of conductor 22. The support could be an organic epoxy or polyimide substrate 21.

The flat conductor 22 is glued onto the substrate 21 and then etched, possibly by chemical machining with iron perchloride using the conventional printed circuit technology. The required value of the resistance R is obtained by varying the length L, the width l and the thickness e of the flat conductor 22 according to the following relation:

$$R = ρ \frac{L}{l e} \qquad ( 1 )$$

where ρ is the resistivity of the flat conductor 22. The thickness e is particularly low, considering that the conductor 22 is obtained by chemical etching.

In order to reduce the total length L_{T} of the resistance as a function of a given width l_{d}, the flat conductor may for example be in the shape of a coil. This coil could possibly comprise straight conductor segments in parallel, with the smallest possible space between two adjacent segments 23, 24. This minimum space is defined by the electrical withstand between the two segments 23, 24. The ends of the coil could terminate in two connection strips to enable wiring of the resistance to two connection wires.

One important problem that needs to be solved is the resistance to flashovers or electrical arcing that are necessarily applied to this type of resistance, as mentioned above. In practice, this resistance to flashovers consists particularly of ensuring that the temperature of the metallic conductor 22 does not get hot enough to deteriorate the organic substrate 21. In this respect it is preferable that the temperature of the conductor 22 during a flashover does not exceed a given temperature, for example of the order of 300° C. Consequently, according to the invention, the mass of the flat conductor must be sufficiently large. For example, if the thickness of the conductor is fixed, the width l and the length L of the flat conductor can be varied to obtain the minimum mass necessary to guarantee that the maximum temperature would not be exceeded during the flashover. Since the resistance R itself is imposed, then the two parameters l and L, for a given thickness e must be varied such that the ratio between the values l and L defining the resistance R according to the previous relation (1) remains constant.

The value of the resistivity ρ of the flat conductor 22 must be sufficient to obtain the resistance value R without necessitating an excessive length, and without introducing any parasitic self-induction effect. One conducting material that satisfies these requirements comprises a nickel alloy. One material that can be used is known under the name NC15Fe according to the AFNOR standard. For example, for a flat conductor made from this material and for a resistance value R of the order 35 ohms, the length L_{T} and the width l_{d} of a resistance according to the invention could be 75 mm and 45 mm respectively, with a space e₁ between two adjacent segments equal to 0.3 mm.

The organic substrate 21 could be placed on a ceramic support to enable the resistance to dissipate heat generated by conduction of the current passing through it, this support also acting as mechanical support, knowing that the low thickness of the organic substrate provides some flexibility. Furthermore, the flat conductor 22 may be covered with an insulating layer that can be of the same nature as the substrate 21, in order to electrically insulate it.

Therefore, FIG. 3 shows a partial sectional view through different component layers of an embodiment of a resistance according to the invention. As mentioned previously, the resistance comprises at least a first organic substrate 21 and a flat conductor 21. A first glue layer 31 is applied between the flat conductor and the first substrate 21 to glue the two elements together. For example, the substrate 21 may be made of a material known under the brand Kapton. The flat conductor 22 is covered by an insulating layer 32, composed for example of a second organic substrate 32 with the same nature as the first 21. A second glue layer 33, with the same nature as the first, is used to glue the insulating layer 32 on the flat conductor. The first substrate 21 is glued onto a ceramic support 34 by means of a third glue layer 35. This ceramic support may be made of alumina. The first and second layers of glue 31, 33 may be acrylic adhesives. The third glue layer 35 may be made of epoxy. The thicknesses of the various component layers of the resistance may be as follows:

ceramic support 34: of the order of one millimeter;

glue layer 35 between the alumina support and the first organic substrate: 25 μm;

organic substrates 21, 32: 75 μm;

glue layers 31, 33 between the organic substrates and the flat conductor: 50 μm;

flat conductor 22: 100 μm.

The previous thicknesses show that the thickness of the resistance could possibly be less than two millimeters depending on the thickness of the ceramic support, or this thickness may be greater but it will always be of the order of a few millimeters.

FIGS. 4 and 5 illustrate another embodiment of a resistance according to the invention. This embodiment advantageously further reduces the size occupied by the resistance. The previous embodiment shows a thin resistance with a relatively small surface area for a high voltage resistance that can for example resist 35 kV for a continuous power of the order of a hundred watts, but this surface area may still be too large for some applications. This may be the case particularly if the mass of the flat conductor, and therefore its length and area, have to be increased in order to further reduce the heating temperature. FIG. 4 shows that the area occupied by the resistance as illustrated in FIGS. 2 and 3 may be halved by folding the resistance on itself as shown in FIG. 4, due to the flexibility of the components. Therefore, the flexible part is actually folded, in other words the flat conductor 22 sandwiched between the two organic substrates 21, 32. This part is folded around the ceramic support 34 that has the particular function of dissipating heat, and accessorily acting as a mechanical support with its surface area being approximately halved. The thickness of the support 34 may possibly be increased to enable the required heat dissipation. FIG. 5 shows a sectional view similar to that in FIG. 3 showing the sequence of component layers of the resistance. The two faces of the ceramic support 34 are covered by the set of layers 35, 21, 31, 22, 33, 32 as shown in FIG. 3. Since the total thickness of this assembly is low, the total thickness of the resistance is still low, although the surface area has been halved.

FIG. 6 shows an embodiment of a resistance according to the invention with a casing. Therefore the resistance comprises a casing 61 in which an assembly like that illustrated in FIGS. 2 to 5 may be fixed. Preferably, the casing 61 contains a resistive assembly folded around a ceramic support as shown in FIGS. 4 and 5, in order to minimize the size. The casing 61 could be in the shape of a flat bottomed ramekin. It is made of ceramic such as alumina, the shape of the casing being obtained by machining the ceramic before sintering. The casing may contain attachment holes 62 that can be used particularly to fix it to a mechanical support, such as a heat sink for a tube emitter. Once the organic support equipped with the flat conductor is fixed at the bottom of the casing, the ends of the connection wires 63, 64 are soldered onto the connection strips, 25, 26 so that the flat conductor can be electrically connected to the outside. The connection wires may be fixed onto the flat conductor 22 by tin-silver soldering (SnAg). The resistance fixed at the bottom of the casing and the connection cables are covered with a protective resin 65 that in particular avoids the need for a cover. The protective resin is hot when it is poured into the casing, and then hardens. Advantageously, this type of machined ceramic casing used with a protective resin may be made economically.

The embodiment of a resistance according to the invention shown with reference to FIG. 2 comprises an organic substrate onto which the flat conductor is fixed. Another embodiment of a resistance according to the invention may be applied in the case in which the substrate or support is not organic, and in this case the support may be made of ceramic. The flat conductor is fixed to the support by means of an organic glue. In this case it is essential to prevent the flat conductor from getting too hot and deteriorating the organic glue.

There are many advantages of a resistance according to the invention. Its printed circuit type structure enables very good reproducibility of resistance values and reliable operation, particularly related to drift. It also has the advantage that it does not depend on rare or uncertain procurement sources. All its components are easy to procure since they are essentially conventional. Therefore, procurement reliability is achieved. Its cost is low, particularly because its component elements are not expensive in themselves, and because it is inexpensive to assemble these elements using conventional printed circuit techniques and to machine the ceramic. Finally, a resistance according to the invention can resist very high voltages, of the order of a few tens of kilovolts while occupying a very small volume.

Therefore it is very suitable for a tube emitter, particularly intended for airborne radar subject to very severe dimensional problems. Therefore, the invention can be used to improve the operating reliability and procurement reliability and to reduce the size of a microwave tube emitter equipped with a limitation resistance as described above with reference to FIGS. 2 to 6. For example, the limitation resistance may be wired onto the cathode of the emitter grid. Two or more resistances may be wired in parallel or in series, depending on the allowable value of the resistance and power obtained. A resistance according to the invention can also be wired onto the tube collector.

In particular, a resistance according to the invention has been described for use as a limitation resistance in a microwave tube power emitter. However it may be used for other applications, such as applications that require similar voltage withstand performances and with similar size or cost constraints.

1. High voltage resistance, characterized in that it comprises at least one support (21) and a flat conductor (22) with length L, width l and thickness e fixed to the support and with a given resistivity ρ, the value R of the resistance being equal to ρL/le, the values of the length L, width l and the thickness e being defined such that the mass of the flat conductor (22) is sufficient to resist electrical arcing without exceeding a given temperature.

2. Resistance according to claim 1, characterized in that said support (21) is an organic substrate.

3. Resistance according to claim 1, characterized in that said conductor (22) is fixed to the support by means of an organic glue.

4. Resistance according to any one of the previous claims, characterized in that said flat conductor (22) is in the shape of a coil.

5. Resistance according to claim 4, characterized in that said flat conductor (22) comprises parallel straight segments (23, 24).

6. Resistance according to any one of the previous claims, characterized in that said flat conductor (22) comprises a nickel alloy.

7. Resistance according to any one of the previous claims, characterized in that said flat conductor (22) is covered by an insulating layer (32).

8. Resistance according to claim 7, characterized in that said insulating layer is an organic substrate.

9. Resistance according to claim 2 and any one of claims 4 to 8, characterized in that said organic substrate is fixed to a ceramic support (34).

10. Resistance according to claim 2 and any one of claims 4 to 8, characterized in that said resistance is folded on itself.

11. Resistance according to claim 10, characterized in that said organic substrate is fixed on the two sides of a ceramic support.

12. Resistance according to any one of the previous claims, characterized in that it comprises connection wires, the ends of which are soldered onto connection strips (25, 26) of said flat conductor (22).

13. Resistance according to any one of the previous claims, characterized in that it is fixed to the bottom of a ceramic casing (61).

14. Resistance according to claim 13, characterized in that said resistance is protected by a resin poured in said casing.

15. Microwave tube emitter, characterized in that it is equipped with one or several limitation resistances according to any one of the previous claims.

16. Emitter according to claim 15, characterized in that said resistance(s) is (are) wired onto the cathode of the tube grid.

17. Emitter according to claim 15, characterized in that said resistance(s) is (are) wired onto the tube collector.
